(19) United States
(12) Patent Application Publication
(10) Pub. No.: US 2018/0042052 A1
(43) Pub. Date: Feb. 8, 2018

(54) COMMUNICATION EFFICIENCY

(71) Applicant: Nokia Solutions and Networks Oy, Espoo (FI)

(72) Inventors: Ilkka Harjula, Oulu (FI); Kari Pekka Pajukoski, Oulu (FI)

(21) Appl. No.: 15/550,989

(22) PCT Filed: Feb. 17, 2015
(86) PCT No.: PCT/EP2015/053281

§ 371 Date: Aug. 14, 2017

(51) Int. Cl. H04W 74/08; H04L 5/06; H04W 72/12; H04L 27/00

(52) U.S. Cl. CPC H04W 74/0833; H04L 27/0014; H04L 5/06; H04W 72/12; H04L 2027/0095

(57) ABSTRACT

There is provided a method comprising: transmitting, by a terminal device, a random access preamble to a network node, receiving a random access response from the network node, determining a transmission band based on the random access response, transmitting a first scheduled transmission signal on the determined transmission band using sub-carrier-wise filtering, using sub-carrier group-wise filtering or by placing at least one blank value at an edge area of at least one frame used for the transmitting, receiving a data transmission grant for a second scheduled transmission signal, and transmitting the second scheduled transmission signal based on the received data transmission grant.

### TECHNICAL FIELD

The invention relates to communications.

### BACKGROUND

The number of terminal devices used for different communication purposes within radio communication networks is increasing. Enhancing the radio communication networks ability to handle increased number of connections may be beneficial for the performance of the network.

### BRIEF DESCRIPTION

According to an aspect, there is provided the subject matter of the independent claims. Some embodiments are defined in the dependent claims.

One or more examples of implementations are set forth in more detail in the accompanying drawings and the description below. Other features will be apparent from the description and drawings, and from the claims.

### BRIEF DESCRIPTION OF DRAWINGS

In the following embodiments will be described in greater detail with reference to the attached drawings, in which

FIGS. 1A to 1B illustrate examples of a radio system to which embodiments of the invention may be applied;

FIGS. 2 to 3 illustrate block diagrams according to some embodiments of the invention;

FIG. 4 illustrates an embodiment of the invention;

FIGS. 5A to 5D illustrate some embodiments of the invention;

FIG. 6 illustrates an embodiment of the invention;

FIGS. 7 to 8 illustrate apparatuses according to some embodiments of the invention; and

FIG. 9 illustrates an embodiment of the invention.

### DETAILED DESCRIPTION OF SOME EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Embodiments described may be implemented in a radio system, such as in at least one of the following: Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and/or 5G system. The present embodiments are not, however, limited to these systems.

The embodiments are not, however, restricted to the system given as an example but a person skilled in the art may apply the solution to other communication systems provided with necessary properties. One example of a suitable communications system is the 5G concept, as listed above. It is assumed that network architecture in 5G will be quite similar to that of the LTE-advanced. 5G is likely to use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates. 5G will likely be comprised of more than one radio access technology (RAT), each optimized for certain use cases and/or spectrum.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent. Some other technology advancements probably to be used are Software-Defined Networking (SDN), Big Data, and all-IP, which may change the way networks are being constructed and managed.

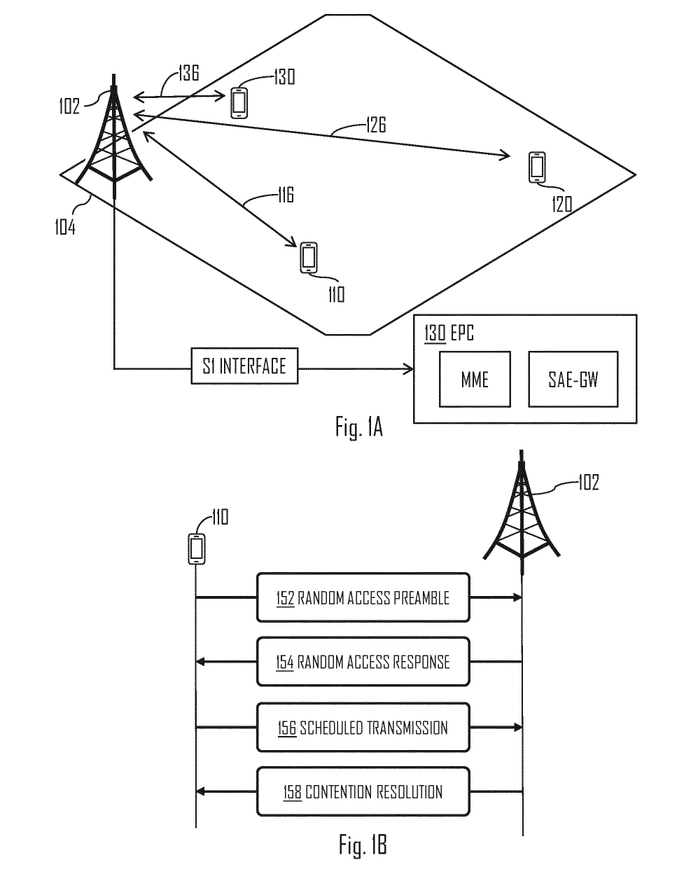

FIGS. 1A to 1B illustrate some examples of a radio system to which embodiments of the invention may be applied. Radio communication networks, such as the Long Term Evolution (LTE), the LTE-Advanced (LTE-A) of the 3^{rd} Generation Partnership Project (3GPP), or the predicted future 5G solutions, are typically composed of at least one network element, such as a network element 102, providing a cell 104. Each cell may be, e.g., a macro cell, a micro cell, femto, or a pico-cell, for example. The network element 102 may be an evolved Node B (eNB) as in the LTE and LTE-A, a radio network controller (RNC) as in the UMTS, a base station controller (BSC) as in the GSM/GERAN, or any other apparatus capable of controlling radio communication and managing radio resources within a cell. For 5G solutions, the implementation may be similar to LTE-A, as described above. The network element 102 may be a base station or a small base station, for example. In the case of multiple eNBs in the communication network, the eNBs may be connected to each other with an X2 interface as specified in the LTE. Other communication methods between the network elements may also be possible. The network element 102 may be further connected via an S1 interface to an evolved packet core (EPC) 130, more specifically to a mobility management entity (MME) and to a system architecture evolution gateway (SAE-GW).

The cell 104 may provide service for at least one terminal device 110, 120, 130, wherein the at least one terminal device 110, 120, 130 may be located within or comprised in the cell 104. The at least one terminal device 110, 120, 130 may communicate with the network element 102 using a communication link(s) 116, 126, 136, which may be understood as communication link(s) for end-to-end communication, wherein source device transmits data to the destination device via the network element 102 and/or core network. The at least one terminal device 110, 120, 130 may reside within some distance from the network element 102, and thus different terminal devices 110, 120, 130 may be within different distances from the network element 102. Further, it is possible that there are other cells in the area of the cell 104. The other cells may be provided, for example, by other network elements providing macro, micro, pico and/or femto cells. The network element 102 and the other network elements may support Dual Connectivity (DC).

The radio system of FIGS. 1A to 1B may support Machine Type Communication (MTC). MTC may enable providing service for a large amount of MTC capable devices, such as the at least one terminal device 110, 120, 130. The at least one terminal device 110, 120, 130 may comprise mobile phones, smart phones, tablet computers, laptops and other devices used for user communication with the radio communication network, such as a MTC network. These devices may provide further functionality compared to the MTC schema, such as communication link for voice, video and/or data transfer. However, in MTC perspective the at least one terminal device 110, 120, 130 may be understood as MTC device(s). It needs to be understood that the at least one terminal device 110, 120, 130 may also comprise other MTC capable devices, such as sensor devices providing position, acceleration and/or temperature information to name a few examples.

In MTC, the radio communication network may need to handle a massive amount of uncoordinated accesses by the MTC devices. As the amount of MTC devices may be quite high, network access may be a limiting factor, compared to the conventional network limitations, where interference and/or limited coverage may pose a problem. Most of the MTC devices may have a small amount of data to be transmitted in sporadic fashion. This may enable the MTC devices to spend majority of time in sleep mode, disconnected from the network element 102 and/or the radio communication network. Thus, the MTC devices may have a requirement of very small energy small energy consumption. However, the sporadic transmissions may cause the MTC devices to transmit an increased amount of random access requests per device to the network element 102, as each data packet transmission may be preceded by a random access procedure. Combined with the massive number of MTC devices, increase of random access requests in the cell 104 may be inevitable.

Referring to FIG. 1B, the random access procedure may comprise, in block 152, transmitting, by the terminal device 110, a Random Access Preamble (RAP) to the network element 102. In block 154, the network element 102 may respond with a Random Access Response (RAR to the terminal device 110. In block 156, the terminal device 110 may transmit a first scheduled transmission to the network element 102. In step 158, the network element 102 may respond with a contention resolution to the terminal device 110.

One problem arising from the increased amount of random access requests may be that the transmitted RAPs, by different terminal devices, may comprise similar identification as the amount selectable identifications may be limited. For example, in LTE-A the amount may be 64 for different RAPs. As the terminal devices may select the same RAP identification and/or the same RAPs, the network element 102 may be unable to separate the terminal devices, and thus may be unable to provide orthogonal radio resources for the terminal devices accordingly. Therefore, the first scheduled transmission may be difficult to be detected from each of the terminal devices, as the terminal devices may try to transmit the first scheduled message using same radio resources, e.g. same time and/or bands, for example.

There is provided a solution for enhancing the random access procedure in the radio system, such as a MTC system. With the provided solution, the detection and/or separation of terminal device transmissions may be enhanced, and thus need for repeated random access processes may be decreased. Therefore, the radio communication network, such as the MTC network, may be able to serve more terminal devices within the network. Although the example of FIG. 1B illustrates a contention based random access procedure, some embodiments of the provided solution may be applicable to non-contention based random access procedure.

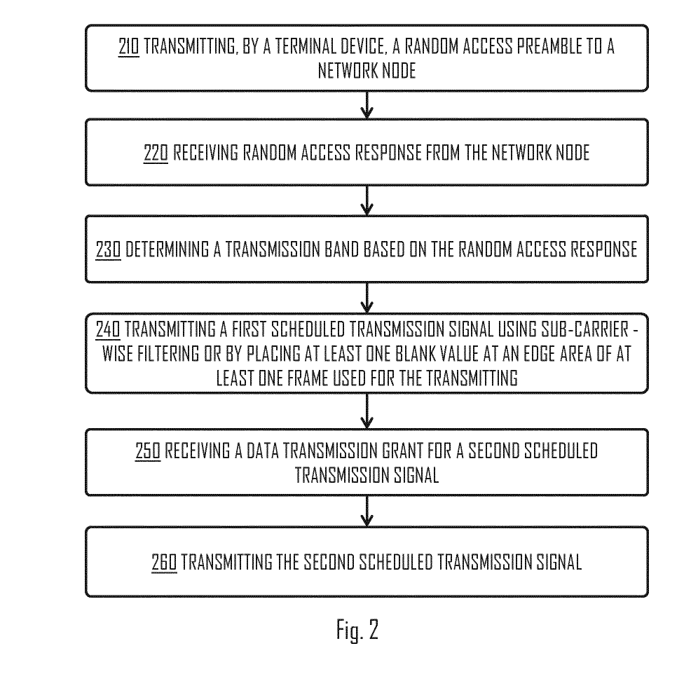

FIG. 2 illustrates a block diagram according to an embodiment of the invention. Referring to FIG. 2, in step 210, a terminal device, such as the at least one terminal device 110, 120, 130, may transmit a RAP to a network node, such as the network element 102. The RAP may be transmitted on a Physical Random Access Channel (PRACH), for example. As said before, the terminal device may select the RAP among a limited amount of RAPs, and thus the selected RAP may be similar and/or identical to a RAP selected and transmitted by another terminal device. The similarity may mean that identification of the selected RAP may be similar to identification of some other selected RAP. Thus, in some cases the selected RAP may differ from other selected RAPs in some parts, but may still comprise same selected identification as do the other selected RAPs.

In step 220, the terminal device may receive a RAR from the network node. The RAR may be received as a response to the transmitted RAP. The RAR may be transmitted on a Downlink Shared Channel (DL-SCH), for example. The RAR may comprise configuration information directed to the terminal device, terminal devices transmitting the similar and/or identical selected RAP, a group of terminal devices selected within a sub-area of the cell and/or all the terminal devices within the cell provided by the network node. Thus, the network node may unicast and/or broadcast the RAR. The configuration information may comprise information, such as permission to transmit a first scheduled transmission and configuration information to perform the transmission, Timing Alignment (TA) command and/or a temporary identity, such as a Cell Radio Network Temporary Identity (C-RNTI) for the next steps of the random access procedure. In an embodiment, the TA command is and/or comprises timing advance command.

In step 230, the terminal device may determine a transmission band based on the received RAR. Thus, the network node may provide the terminal device with information about the transmission band on which the terminal device may continue the random access procedure. In other words, the network node may provide the terminal device radio resources and/or information about the radio resources for transmission. The determined transmission band may be the transmission band used for a first scheduled transmission signal. The transmission band may comprise one or more sub-bands which may be used for the transmission.

In step 240, the terminal device may transmit, in response to the reception of the random access response in step 220, the first scheduled transmission signal on the determined transmission band using sub-carrier-wise filtering, using sub-carrier group-wise filtering or by placing at least one blank value at an edge area of at least one frame used for the transmitting. The first scheduled transmission signal may be transmitted to the network node from which the RAR was received.

The sub-carrier-wise filtering may mean that one or more sub-carriers of the first scheduled transmission signal are filtered per sub-carrier. For example, it may be possible to filter the first scheduled transmission signal per sub-carrier.

The sub-carrier group-wise filtering may mean that one or more groups of sub-carriers are selected among the first scheduled transmission signal, and each selected group, of one or more sub-carriers, is filtered per group. For example, all of the sub-carriers used for the transmission of the first scheduled transmission signal may be filtered as a group. The one or more groups of sub-carriers may be allocated to a single user, such as the user of the terminal device. It should be appreciated that filtering may be carried out sub-carrier-wise also inside a sub-carrier group, such as said one or more groups.

As said, it may be possible to place at least one blank value at the edge area of the at least one frame used for the transmitting. The at least one blank value may comprise zero(s), for example. The at least one blank value may be a bit and/or a symbol, such as a data bit and/or a data symbol. Thus, the at least one blank value may be placed using one or more data bits and/or one or more data symbols that comprise zero value(s), for example. For example, the data symbol may comprise multiple adjacent blank values. Further, the at least one frame may comprise radio frame(s), such as an Orthogonal Frequency Division Multiplexing (OFDM) frame(s), Orthogonal Frequency Multiple Access (OFDMA) frame(s), or Single Carrier Frequency Division Multiple Access, SC-FDMA frame(s) or comprise corresponding symbol(s). The placing of blank values at the edge area of the at least one frame may modulate the frame.

As described earlier, the first scheduled transmission signal may be transmitted on the determined transmission band. Further, the term scheduled may mean that the first scheduled transmission signal is transmitted on a scheduled transmission and/or receiving window. The transmission and/or receiving window may be determined by the network node, and the network node may transmit the information about the scheduling to the terminal device. Information about the scheduling of the first scheduled transmission signal may be transmitted, for example, in the RAR. The terminal device may determine the correct transmission time from the received information.

The used method(s) may provide an enhanced spectral containment of the first scheduled transmission signal, which may mean that the first scheduled transmission signal may be more easily detectable among a plurality of first scheduled transmission signals transmitted by different terminal devices. For example, if two terminal devices are transmitting on the same determined transmission band, based on the same received RAR, the enhanced spectral containment, achieved using the above described method(s), may allow the network node to detect and/or receive both first scheduled transmission signals. This may be possible, for example, as said method(s) may increase the spectral efficiency of the first scheduled transmission signals, by reducing the amount of used frequency spectrum per transmission, for example.

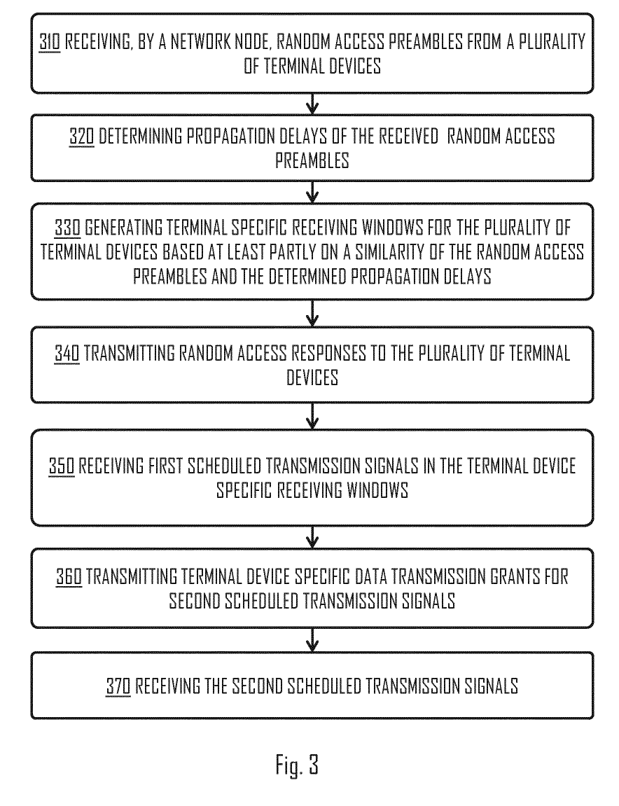

By using, by the terminal device, one of the above-described enhanced method(s) for the transmission, such as the sub-carrier-wise filtering, sub-carrier group-wise filtering or the placing of at least one blank value at the edge area of the at least one frame used for transmitting, the network node may be able to more easily detect first scheduled transmissions from different terminal devices. More precisely, the enhanced method(s) may enhance the detection by the network node in situations, wherein two or more terminal devices have selected the same RAP. The implementations of the enhanced transmission method(s) are discussed later in more detail with reference to FIG. 4.

In step 250, the terminal device may receive, in response to the transmission of the first scheduled transmission signal, a data transmission grant, from the network node, for a second scheduled transmission signal. As with the first scheduled transmission signal, the network node may provide radio resources, e.g. transmission band and/or time slot, for the transmission of the second scheduled transmission signal. The radio resource information may be comprised in the received data transmission grant.

In step 260, the terminal device may transmit, to the network node, the second scheduled transmission signal based on the received data transmission grant. The second scheduled transmission signal may comprise data, such as uplink data for example. The transmission grant may be comprised in the contention resolution, for example.

FIG. 3 illustrates a block diagram according to an embodiment of the invention. Referring to FIG. 3, in step 310, a network node, such as the network node of FIG. 2, may receive RAPs from a plurality of terminal devices. For example, two or more terminal devices may each transmit a RAP. The plurality of terminal devices may be similar to the terminal device of FIG. 2. The plurality of terminal devices may transmit the RAPs substantially at the same time. It may also be possible that the RAPs are transmitted within some predetermined window, and thus the exact transmission time may vary between the plurality of terminal devices. Further, the plurality of terminal devices may obtain configuration information, from device memory or by receiving the information, wherein the configuration information may cause the plurality of terminal devices to change the transmission time according to the configuration information. Later it may discussed, how variation of the exact transmission time may be achieved.

In step 320, the network node may determine propagation delays of the received RAPs. The propagation delay may be the time that the transmitted signal takes to reach the receiver, in this case the network node. The propagation delay may be understood as the interval between starting the transmission and the starting of receiving. As terminal devices within the cell, provided by the network node, may be within different distances from the network node, the propagation delays may vary. Although the time in the air interface may be short, the differences may detectable and/or measurable by the network node.

In an embodiment, the propagation delay comprises the delay time that is caused by the varying transmission start time. Thus, if the transmission start is delayed, the propagation delay may increase.

In step 330, the network node may generate terminal device specific receiving windows for the plurality of terminal devices based at least partly on a similarity of the RAPs and the determined propagation delays. As the network node may be able to detect the different transmissions, comprising the same identification, using the delay dimension, the network node may generate the terminal device specific receiving windows, even though the network node could not identify the different terminal devices, The terminal device specific receiving windows may be targeted for the enhanced transmission method(s), and thus the network node may be aware, in general, of the modulations in time and/or frequency dimensions. The receiving windows may be then used more efficiently as the enhanced transmission method(s) may be more spectral efficient. Further, the receiving windows may be understood to comprise time and/or frequency dimensions. Thus, the receiving windows may be targeted for certain band(s) and/or certain time slot(s). It should be appreciated that the determination of the propagation delays may be triggered based on the observation of RAPs, received from the plurality of terminal devices, being similar or identical. Another option is that the propagation delays are determined to all RAPs. Therefore, it may be possible that the received RAPs are not necessarily similar, and thus the plurality of terminal devices may select different, similar, and/or identical RAPs.

In step 340, the network node may transmit RARs to the plurality of terminal devices. The RARs may be responses to the received RAPs. As said, the transmission may be unicasting and/or broadcasting and comprise configuration information for the terminal devices. The same RAR may be transmitted to each of the plurality of terminal devices.

In step 350, the network node may receive the first scheduled transmission signals from the plurality of terminal devices in the terminal device specific receiving windows. The first scheduled transmission signals may be received in response to the transmitting of the RARs. This may mean that the network node may listen for and/or expect the first scheduled transmission signals during a certain time slot(s) and/or on certain band(s), and receive the said signals on said receiving windows. It is possible, however, that not all of the transmitted first scheduled transmission signals are received. It may be that the network node receives at least one first scheduled transmission signal from at least one terminal device.

In step 360, the network node may transmit, in response to the receiving of the first scheduled transmission signals, terminal device specific data transmission grants, wherein the data transmission grants are for second scheduled transmission signals. The data transmission grants may be transmitted to each of the plurality of terminal devices. The data transmission grants may be terminal device specific, and thus each of the plurality of terminal devices may receive the terminal device specific data transmission grant. The terminal specific data transmission grants may be possible, as the first scheduled transmission signals may comprise terminal device identification, and thus the different terminal devices may be, not only detectable, but separable, and further identifiable. Further, it is possible in the case that at least one first scheduled transmission signal is received, that the network node transmits the data transmission grant(s) to the at least one terminal device from which the at least one first scheduled transmission signal was received. In an embodiment, the data transmission grant(s) are unicasted.

In step 370, the network node may receive, in response to the transmitting of the data transmission grants, the second scheduled transmission signals. As in steps 350 and 360, it may be possible that at least one second scheduled transmission signal is transmitted according to the number of received and/or detected first scheduled transmission signals and/or successful data transmission grant transmission(s). As described in relation to FIG. 2, the second scheduled transmission signal may comprise, for example, uplink data from the plurality of terminal devices. The second scheduled data transmission signals may be more easily detectable compared to the first scheduled transmission signals, as each terminal device may be given terminal device specific data transmission grant. Thus, radio resources may be allocated per terminal device with a terminal device specific radio resource allocation.

The random access procedure may take advantage of delay separation of different terminal devices, and thus the receiver may be able to detect terminal devices that may have selected identical random access signature for the RAP. By exploiting the channel information extracted from the RAP and/or by applying successive interference cancelling (SIC) receiver, the receiver may be capable of more effectively detecting the colliding transmissions of users sharing the same temporary identity.

In an embodiment, the RAPs received in step 310 are similar to each other. In an embodiment, the received RAPs are substantially identical. In another embodiment, the received RAPs comprise different RAPs.

The embodiments described with reference to FIGS. 2 to 3 and hereinafter, may increase number of serviced users and/or terminal devices per cell as the delay domain may be used without a need for additional communication between the network node and the terminal devices. Thus, each avoided restart of the random access process may save radio resources. Further, the proposed solution may act as one enabler for low latency communication in random access process within small cells. Let us now look closer on the filtering of the first scheduled transmission signal in step 240 with reference to an embodiment of FIG. 4. Referring to FIG. 4, in block 410, the terminal device may generate data for the first scheduled transmission signal. The generated data may comprise, for example, Radio Resource Control (RRC) message. In block 420, the terminal device may apply filtering for the data of the first scheduled transmission signal. The filtering may be performed by using sub-carrier-wise filtering, wherein the sub-carrier-wise filtering comprises filtering per sub-carrier of the first scheduled transmission signal (block 422). Further, the filtering may be performed by using sub-carrier group-wise filtering, wherein filtering per group of sub-carriers within a sub-band of the transmission band (block 424) may be used. The group of sub-carriers may comprise a group of consecutive and/or adjacent sub-carriers, for example. One possibility may be to place at least one blank value, such as at least one zero, at an edge area of at least one frame the end of the first scheduled transmission signal (block 426).

In an embodiment, the sub-carrier group-wise filtering comprises filtering the first scheduled transmission signal over the transmission band of the first scheduled transmission signal. Thus, all sub-carriers used for the transmission may be filtered as a group.

In an embodiment, the filtering per one sub-carrier of the first scheduled transmission signal is performed using Filter Bank Multi-Carrier (FBMC) modulation. Thus, each sub-carrier may be filtered separately. The FBMC may enable the first scheduled transmission signal to be designed in the frequency domain to have desired spectral containment. Further, FBMC systems may not require redundant Cyclic Prefix (CP), and thus may be more spectral efficient.

In an embodiment, the filtering per group of sub-carriers within a sub-band of the transmission band is performed using Universal-Filtered Multi-Carrier (UFMC) modulation. Thus, the filtering may be performed per sub-band of the transmission band. As said, the group of sub-carriers may comprise sub-carriers that are consecutive to each other, thus focusing the filtering allocation to a single user. The UFMC may reduce out out-of-band side-lobe levels of the first scheduled transmission signal, and subsequently reduce the potential Inter-Carrier Interference (ICI) between adjacent users and/or terminal devices in case of asynchronous transmissions.

In an embodiment, the UFCM is used to filter all the sub-carriers used for the transmission of the first scheduled transmission signal, wherein the sub-carriers are filtered as one group.

In an embodiment, the terminal device places at least one blank value at an edge area of at least one frame used for the transmission of the second scheduled transmission. Thus, the second scheduled transmission signal may be modulated similarly as may be one possibility for the first scheduled transmission signal.

In an embodiment, the placing of the at least one blank value at the edge area of the at least one frame used for the transmission of the first scheduled transmission signal and/or the second scheduled transmission signal is performed by placing a set of zeros at a tail of the orthogonal frequency-division multiple access (OFDMA) or single carrier frequency division multiple access (SC-FDMA) symbols of the first scheduled transmission signal and/or the second scheduled transmission signal respectfully.

In an embodiment, the set of zeros placed at the tail of the OFDMA or SC-FDMA symbols of the second scheduled transmission signal is shorter compared to the set of zeros placed at the tail of the OFDMA or SC-FDMA symbols of the first scheduled transmission signal. This may mean that the number of zeros in the set of zeros placed at the tail of the OFDMA or SC-FDMA symbols of the second scheduled transmission signal is lesser compared to the number of zeros in the set of zeros placed at the tail of the OFDMA or SC-FDMA symbols of the first scheduled transmission signal.

In an embodiment, the placing of at least one blank value at an edge area of at least one frame used for the transmission of the first scheduled transmission signal and/or the second scheduled transmission signal is performed using a zero-tail Discrete Fourier Transform-spread-Orthogonal Frequency Division Multiplexing, DFT-s-, modulation. In zero-tail DFT-s-OFDM, a set of zeros may be placed at the tail of the first scheduled transmission signal providing an enhanced spectral containment of said signal. This may be achieved, not by zeroing the outputs of Inverse Fast Fourier Transform (IFFT), but by baseband processing of the first scheduled transmission signal prior the IFFT. By applying this filtering and/or modulation, a short CP may be used and/or CP may be omitted completely, depending on the situation and/or radio system requirements.

Using the described filtering and/or modulation for the first scheduled transmission signal and/or the second scheduled transmission signal may enhance the transmission of the said signals, and more precisely reduce adjacent band interference for said signals. Further, the network node may be able to better detect different first scheduled transmission signals and/or second scheduled transmission signals from different sources, as the signals may be more robust for interference. It may also be possible that the receiving windows may be generated so that they are more efficient compared to a situation where described filtering is not being used.

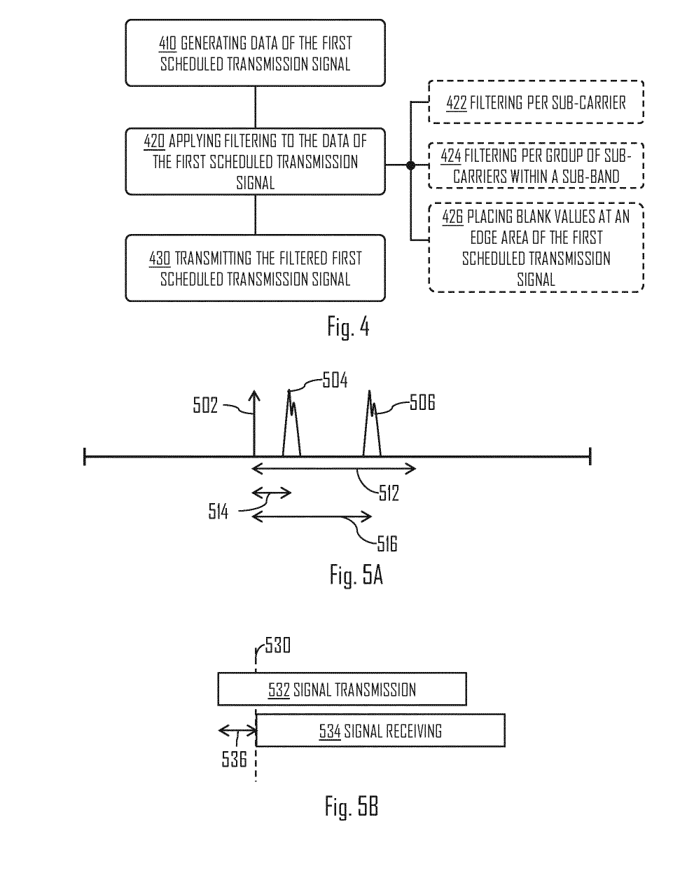

FIGS. 5A to 5D illustrate some embodiments of the invention. Referring to FIG. 5A, the RAP(s) may be transmitted by the terminal device(s) as indicated by an arrow 502. The arrow 502 may indicate that a single terminal device transmits a single RAP, and/or the at least two terminal devices each transmit a single RAP substantially simultaneously.

In the case of first terminal device transmitting a first RAP and a second terminal device transmitting a second RAP, the network node may receive both the first and the second RAPs 504, 506, wherein the first and the second RAPs are similar, identical and/or comprise substantially same identification. The time between the transmission of the first and second RAPs 502 and the receiving of said RAPs 504, 506 may vary. Variation may be caused by different propagation delays 514, 516 caused by different distances between the terminal devices and the network node. Using the propagation delays 514, 516, the network node may detect and receive the similar RAPs 504, 506 transmitted substantially at the same time and/or within a certain time window. In an embodiment, the first and the second terminal devices are comprised in the at least one terminal device 110, 120, 130.

Still referring to FIG. 5A, uplink timing uncertainty may be indicated with a time interval 512. The uplink timing uncertainty may mean that the terminal device(s), such as the first and the second terminal devices, may transmit the RAPs in various times within the time interval 512. One way is to add a uniformly distributed delay to the transmission of the RAP. This may widen the span of the RAPs arriving to the network node, and therefore may make the detection of different RAPs easier for the network node. In this case, time interval 512 may cope with the increased delay span of the first and the second terminal devices. If the distance from the network node is known, one way to approach uniform distribution may be to advance the timing of randomly selected terminal devices that are in a region far from the network node. In an embodiment, the terminal device may determine that it is farther from the network node than a predetermined value. Based on said determination, the terminal device may adjust the timing advance with a value obtained from a uniformly distributed function. In an embodiment, said adjusting may happen after a random selection. That is, the terminal device may randomly select whether or not to perform said adjusting. In an embodiment, the random selection happens anywhere in the cell. In another embodiment, the random selection happens if the terminal device is farther from the network node than the predetermined value.

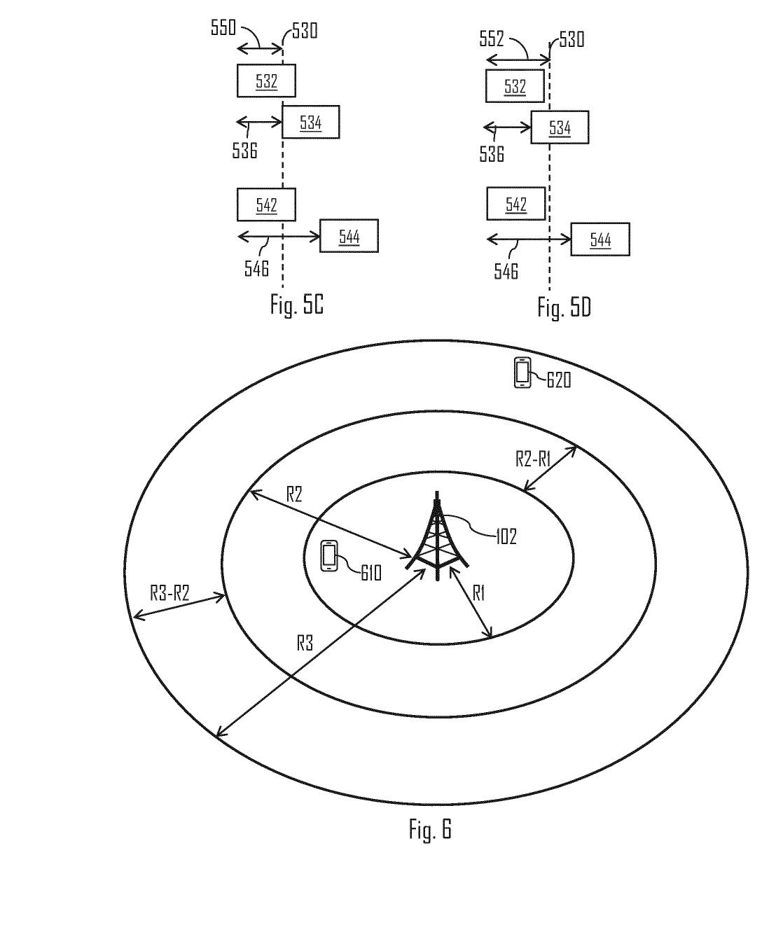

Referring to FIG. 5B, the first scheduled transmission signal may be transmitted 532 by a terminal device, such as the terminal device described in relation to FIG. 2. The first scheduled transmission signal may be received 534 by a network node, such as the network node of FIG. 3. As with the transmission of RAP(s), the first transmission signal and/or the second transmission signal may travel for some time in the air interface, wherein the time may be dependent on the distance between the source and the receiver. In FIG. 5B, the first scheduled transmission signal may be received at a desired time 530 wherein the desired time 530 may imply that the time is suitable and/or desirable by the receiver, e.g. the network node. In order to achieve this, the terminal device may adjust the timing advance of the transmission of the terminal device. The transmission of the terminal device may refer to the transmission of the RAP, as discussed later in more detail with reference to FIG. 6, to the transmission of the first scheduled transmission signal, and/or the transmission of the second scheduled transmission signal.

In an embodiment, the same timing advance value is used, by the terminal device, in the RAP transmission, with the first scheduled transmission signal and/or with the second scheduled transmission signal. In another embodiment, the separate timing advance values are used for the RAP transmission, for the first scheduled transmission signal, and/or for the second scheduled transmission signal. Further, it may be possible that the timing advance value is used for only one of the RAP transmission, the first scheduled transmission signal, or for the second scheduled transmission signal. In another embodiment, the timing advance may change between the transmission of the RAP, the transmission of the first scheduled transmission signal, and the transmission of the second scheduled transmission signal. This may be caused by a command from the network node and/or determination performed by the terminal device(s).

Still referring to FIG. 5B, the propagation delay may be illustrated with an interval 536. The effect of the propagation delay may be possible to modify with the use of the timing advance of the terminal device transmission. As said, the terminal device may adjust the timing advance value, and thus change transmission time and desired time 530 of the first scheduled transmission signal and/or the second transmission signal. More precisely, the receiving time 530 may refer to the time on which the receiving starts. If the terminal device would not change the timing advance value, the first scheduled transmission and/or the second transmission signal may be received at the network node after the indicated desired time 530. In an embodiment, the timing advance value may correspond to the propagation delay 536. Thus, absolute values of timing advance value and the propagation delay may be equal.

In an embodiment, the terminal device adjusts the timing advance value of the transmission of the first scheduled transmission signal and/or the timing advance value of the transmission of the second scheduled transmission signal. The timing advance value may be common and/or separate for the transmission of the first and the second scheduled transmission signals. Thus, it may be possible to adjust the timing advance value for both transmissions separately, for example. In an embodiment, the RAR, transmitted by the network node to the terminal device(s), comprises a timing advance command, wherein the timing advance value of the transmission of the first scheduled transmission signal and/or the timing advance value of the transmission of the second scheduled transmission signal are adjusted, by the terminal device, according to the timing advance command. The timing advance command may be common timing advance command meaning that the timing advance command, transmitted by the network node, may be common for all of the terminal devices using the same RAP.

The common timing advance command may comprise the timing advance value and/or some indication of the desired timing advance value. In an embodiment, the common timing advance command comprises an indication, wherein the indication indicates a certain timing advance value. The receiving of the timing advance command may cause the terminal device(s) to adjust the timing advance value. In an embodiment, the terminal device(s) adjusts the timing advance, such as the timing advance value, based on the timing advance command received from the network node.

In an embodiment, the common timing advance command, comprised in the RAP, is a first timing advance command, wherein the timing advance value of the transmission of the first scheduled transmission signal is adjusted according to the first timing advance command, wherein the data transmission grant, received in step 250 of FIG. 2, comprises a second timing advance command, and wherein the timing advance value of the transmission of the second scheduled transmission signal is adjusted according to the second timing advance command. Hence, it may be possible to control both the timing advance value of the transmission of the first scheduled transmission signal and the timing advance value of the transmission of the second scheduled transmission signal with separate timing advance commands. Further, it may be possible to transmit, by the network node, the common timing advance command controlling the timing advance value of the first scheduled transmission signal, and to transmit terminal device specific timing advance values for the second scheduled transmission signals. Using the terminal device specific timing advance values, it may be possible to receive each of the second scheduled transmission signals at desired times. The terminal device specific timing advance values may not necessarily be different for each terminal device. Rather, it may enable to use different timing advance values for terminal devices that have selected the same RAP.

In an embodiment, the network node generates the common timing advance command based on the determined propagation delays of RAPs transmitted by terminal devices, similar to the terminal device of FIG. 5B. Each of the terminal devices may transmit one RAP, wherein the generating of the common timing advance command may be based on the transmitted RAPs, and more precisely on the propagation delays.

In an embodiment, the adjusting of the timing advance value comprises increasing the timing advance value. This may mean that the transmission of the terminal device may be advanced. In an embodiment, the adjusting of the timing advance value comprises decreasing the timing advance value. Thus, the transmission of the terminal device may be delayed. The timing advance value may be illustrated with a negative and/or positive number indicating, for example, microseconds. Depending on the radio system configuration both negative and positive numbers may be used to indicate the decreasing and/or increasing of the timing advance value.

In FIG. 5C, transmission and receiving of two separate scheduled transmission signals are shown. The signals may be, for example, the first and/or the second scheduled transmission signals. A first signal may be transmitted (block 532) by, for example, a first terminal device, and a second signal may be transmitted (block 542) by a second terminal device. The receiving of the first and the second signals, by the network node, may be shown with blocks 534, 544. The first and the second terminal devices may have chosen the same RAPs in the beginning of the random access process.

The first and second signals may have different propagation delays 536, 546. These delays 536, 546 cause the signals to be received 534, 544 at different times. The network node may be aware of the actual receiving times for the first and the second signals, although the desired receiving time for the network node would be the desired time 530. This may be due to a fact that the RAPs from the first and the second terminal devices may have been received earlier, thus revealing the propagation delays 536, 546.

As shown in FIG. 5C, the first and the second signals may be transmitted substantially at the same time. This may be caused by the substantially similar propagation delays. In an embodiment, the first and the second terminal devices receive the same RAR. Therefore the timing advance command, and more precisely the common timing advance command, in the RAR may be the same for both terminal devices.

Still referring to FIG. 5C, for example, the different first scheduled transmissions may be received 534, 544 at least partially at the same time. The network node may generate at least one guard band between the terminal specific receiving windows. The network node may also use an advanced receiver to detect and/or receive at least one of the transmitted RAPs, the first scheduled transmission signals and/or the second scheduled transmission signals. The advanced receiver may comprise receivers, like Interference Rejection Combiner (IRC) and/or Interference Cancellation (IC) receiver. These may enable the network node to detect the RAPs, the first scheduled transmission signals and/or the second scheduled transmission signals from the at least two terminal devices. At the beginning of the listening, the network node may estimate time offsets of candidates, e.g. terminal devices, by exploiting channel information extracted from the RAP following channel weights estimation for each candidate, and finally blind detection.

Referring to FIG. 5D, the timing advance value may be generated on the basis of the determined propagation delays of the RAPs transmitted by the first and the second terminal devices. Thus, the timing advance value may be based on both propagation delays 536, 546. This may enable the first scheduled transmission to be received closer to the desired time 530. However, now it may be possible that none of the first transmission signals is received exactly on the desired time. As described, the timing advance value may be generated by the network node and transmitted in the RAR to the terminal devices.

In an embodiment, the network node determines desired timing advance values for the terminal devices, such as the first and the second terminal devices, based on the propagation delays of the RAPs. The desired timing advance values may mean individual timing advance values that would cause the network node to receive transmissions from the terminal devices at the desired time 530. In an embodiment, the desired time may be different for the different terminal devices. The network node may then generate the common timing advance command, wherein the timing advance value of the timing advance command may be an average of the desired timing advance values. As said earlier, the timing advance value may be indicated in other ways than just in a specific number.

It needs to be noted that the receiving windows for different terminal devices may be generated so that they may not necessarily comprise the desired time 530. The use of enhanced transmission method(s) may enable the network node to generate the receiving windows more efficiently, and so that different transmissions may be detected and received.

FIG. 6 illustrates an embodiment of the invention. Referring to FIG. 6, a first and a second terminal device 610, 620 are shown within a cell provided by the network element 102. As described, the network element 102 may be the network node introduced in relation to FIGS. 2 and 3. The cell may have different regions. In one embodiment, the regions are rings around the center of the cell. For example, one sub-region may then be a circle which has a radius of R1. Other sub-regions may be a space between R2 and R1, and a space between R3 and R2, for example.

The terminal device 610, 620 may determine that the terminal device 610, 620 is within a sub-region, such as the above-mentioned regions, of the cell provided by the network element 102. The determination may be based on the distance from the network element 102. The terminal device 610, 620 may then adjust the timing advance of the RAP transmission based on to the determined sub-region.

In an embodiment, adjusting of timing advance comprises adjusting a timing advance value, a timing advance threshold value, and/or timing advance probability. Therefore, the timing advance value may be adjusted by the terminal device in relation to the RAP transmission.

In an embodiment, the terminal device 610, 620 determines whether the terminal device 610, 620 is within a first sub-region or a second sub-region of a cell provided by the network node, wherein the first sub-region is farther away from the network element 102 compared to the second sub-region, and adjusts the timing advance value of the RAP transmission to a first value if the terminal device 610, 620 is within the first sub-region, or adjusts the timing advance value of the RAP transmission to a second value if the terminal device 610, 620 is within the second sub-region. This may mean that the timing advance value of the RAP transmission is greater when the terminal device 610, 620 is farther away from the network element 102.

It may be beneficial for the operation of the radio system, and especially for the detection of different transmissions by the network element 102, that the separation of the transmissions by the terminal devices 610, 620 would be uniformly distributed. Two things may have an effect on the separation: timing advance values and/or propagation delays. To increase the uniform distribution of the transmission receiving timings, the timing advance value may be adjusted by a value obtained from a uniformly distributed function. In an embodiment, the timing advance command comprises the value obtained from the uniformly distributed function. Thus, the network element 102 may control the distribution. Using the uniformly distributed values to adjust the timing advance may not necessarily make the timings of the transmissions uniformly distributed. However, it may bring the timings closer to the uniform distribution. This may, for example, widen the span of the RAPs arriving to the network element 102, and therefore may make the detection of different RAPs easier. In this case, guard time may have to cope with the increased delay spans of the terminal devices 610, 620, meaning that the RAPs may not be delayed or advances so that they arrive to the network node during some other receiving window. Same rule may apply for the transmission of the first scheduled transmission signals and/or the second scheduled transmission signals.

In an embodiment, the terminal device 610, 620 adjusts the timing advance value of the RAP transmission with a value obtained from a uniformly distributed function. This may enhance the network node's ability to detect similar RAP transmissions from multiple sources. For example, when the terminal devices, at regions far from the network node, increase the timing advance value of the RAP transmission, the receiving of the signals, by the network node, from different sources may be more evenly distributed.

In an embodiment, if the distance between the terminal devices and the network element 102 is known, a simple and effective way to approach uniform distribution may be to advance the timing of randomly selected terminal devices that are in a region far from the network element 102. For example, in a cell with a radius of 100 m, all terminal devices closer than 75 m from the network element 102 may transmit their RAPs without an advance. However, all terminal devices further than 75 m from the network element 102 may have a 50% change of using −500 ns advance in timing relative to the measured downlink frame. This kind of arrangement may bring gain in the number of serviced users compared to the case where the transmitted RAPs are not adjusted.

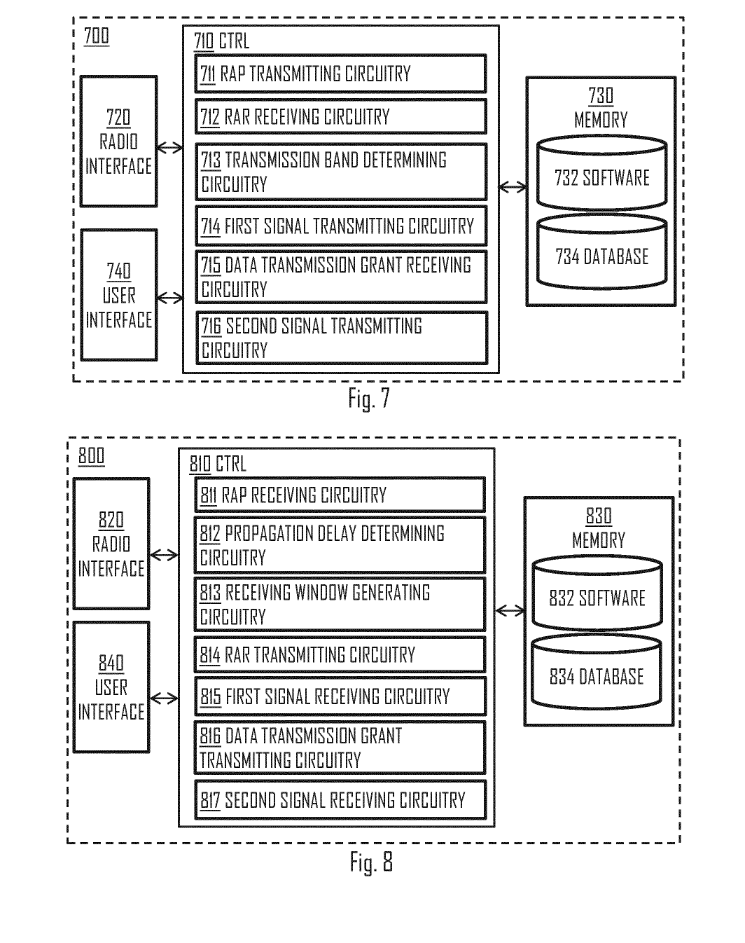

FIGS. 7 to 8 provide apparatuses 700, 800 comprising a control circuitry (CTRL) 710, 810, such as at least one processor, and at least one memory 730, 830 including a computer program code (software) 732, 832, wherein the at least one memory and the computer program code (software) 732, 832, are configured, with the at least one processor, to cause the respective apparatus 700, 800 to carry out any one of the embodiments of FIGS. 1 to 6, or operations thereof.

In an embodiment, these operations may comprise tasks, such as, transmitting, by a terminal device, a random access preamble to a network node, receiving, in response to the transmission of the random access preamble, a random access response from the network node, determining a transmission band based on the random access response, transmitting, in response to the reception of the random access response, a first scheduled transmission signal on the determined transmission band using sub-carrier-wise filtering, using sub-carrier group-wise filtering or by placing at least one blank value at an edge area of at least one frame used for the transmitting, receiving, in response to the transmission of the first scheduled transmission signal, a data transmission grant for a second scheduled transmission signal, and transmitting, to the network node, the second scheduled transmission signal based on the received data transmission grant.

In an embodiment, these operations may comprise tasks, such as, receiving, by a network node, random access preambles from a plurality of terminal devices, determining propagation delays of the received random access preambles, generating terminal device specific receiving windows for the plurality of terminal devices based at least partly on a similarity of the random access preambles and the determined propagation delays, transmitting, in response to the receiving of the random access preambles, random access responses to the plurality of terminal devices, receiving, in response to the transmitting of the random access responses, first scheduled transmission signals in the terminal device specific receiving windows, transmitting, in response to the receiving of the first scheduled transmission signals, terminal device specific data transmission grants, wherein the data transmission grants are for second scheduled transmission signals, and receiving, in response to the transmitting of the data transmission grants, the second scheduled transmission signals.

Referring to FIG. 7, the memory 730 may be implemented using any suitable data storage technology, such as semiconductor based memory devices, flash memory, magnetic memory devices and systems, optical memory devices and systems, fixed memory and removable memory. The memory 730 may comprise a database 734 for storing data.

The apparatus 700 may further comprise radio interface (TRX) 720 comprising hardware and/or software for realizing communication connectivity according to one or more communication protocols. The TRX may provide the apparatus with communication capabilities to access the radio access network, for example. The TRX may comprise standard well-known components such as an amplifier, filter, frequency-converter, (de)modulator, and encoder/decoder circuitries and one or more antennas.

The apparatus 700 may also comprise user interface 740 comprising, for example, at least one keypad, a microphone, a touch display, a display, a speaker, etc. The user interface 740 may be used to control the respective apparatus by a user of the apparatus 700.

In an embodiment, the apparatus 700 may be or be comprised in a terminal device, such as a mobile phone or cellular phone for example. The apparatus 700 may be the at least one terminal device 110, 120, 130, for example. In an embodiment, the apparatus 700 is the terminal device performing the steps of FIG. 2.

The control circuitry 710 may comprise a RAP transmitting circuitry 711 configured to transmit a RAP to a network node, a RAR receiving circuitry 712 configured to receive, in response to the transmission of the random access preamble, a RAR from the network node, a transmission band determining circuitry 713 configured to determine a transmission band based on the RAR, a first signal transmitting circuitry 714 configured to transmit, in response to the reception of the random access response, a first scheduled transmission signal on the determined transmission band using sub-carrier-wise filtering, using sub-carrier group-wise filtering or by placing at least one blank value at an edge area of at least one frame used for the transmitting, a data transmission grant receiving circuitry 715 configured to receive, in response to the transmission of the first scheduled transmission signal, a data transmission grant for a second scheduled transmission signal, and a second signal transmitting circuitry 716 configured to transmit, to the network node, the second scheduled transmission signal based on the received data transmission grant. Naturally, it may be possible that, for example, the functions of circuitries 714, 716 may be performed in a single circuitry.

Referring to FIG. 8, the memory 830 may be implemented using any suitable data storage technology, such as semiconductor based memory devices, flash memory, magnetic memory devices and systems, optical memory devices and systems, fixed memory and removable memory. The memory 830 may comprise a database 834 for storing data.

The apparatus 800 may further comprise radio interface (TRX) 820 comprising hardware and/or software for realizing communication connectivity according to one or more communication protocols. The TRX may provide the apparatus with communication capabilities to access the radio access network and enable communication between network nodes, and between network node and terminal devices, for example. The TRX may provide the apparatus 800 connection to a X2 interface, for example. The TRX may comprise standard well-known components such as an amplifier, filter, frequency-converter, (de)modulator, and encoder/decoder circuitries and one or more antennas.

The apparatus 800 may also comprise user interface 840 comprising, for example, at least one keypad, a microphone, a touch display, a display, a speaker, etc. The user interface 840 may be used to control the respective apparatus by a user of the apparatus 800.

In an embodiment, the apparatus 800 may be or be comprised in a base station (also called a base transceiver station, a Node B, a radio network controller, or an evolved Node B, for example). The apparatus 800 may be the network element 102, for example. Further, the apparatus 800 may be the network node performing the steps of FIG. 3.

The control circuitry 810 may comprise a RAP receiving circuitry 811 configured to receive RAPs from a plurality of terminal devices, propagation delay determining circuitry 812 configured to determine propagation delays of the received RAPs, receiving window generating circuitry 814 configured to generate terminal device specific receiving windows for the plurality of terminal devices based at least partly on a similarity of the RAPs and the determined propagation delays, a RAR transmitting circuitry 814 configured to transmit, in response to the receiving of the RAPs, RARs to the plurality of terminal devices, a first signal receiving circuitry 815 configured to receive, in response to the transmitting of the RARs, first scheduled transmission signals in the terminal device specific receiving windows, a data transmission grant transmitting circuitry 816 configured to transmit, in response to the receiving of the first scheduled transmission signals, terminal device specific data transmission grants, wherein the data transmission grants are for second scheduled transmission signals, and a second signal receiving circuitry 817 configured to receive, in response to the transmitting of the data transmission grants, the second scheduled transmission signals.

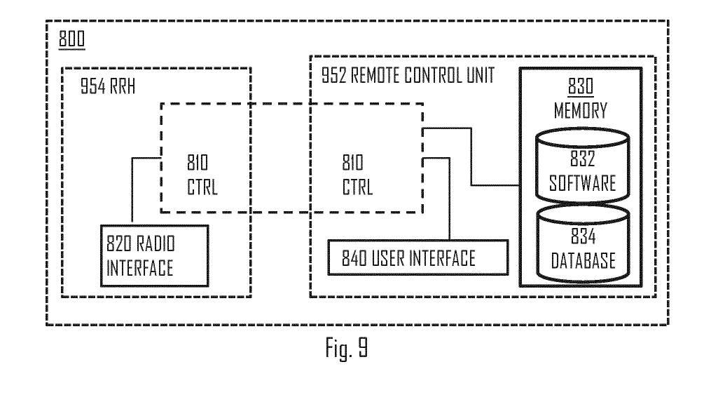

In an embodiment, as shown in FIG. 9, at least some of the functionalities of the apparatus 800 may be shared between two physically separate devices, forming one operational entity. Therefore, the apparatus 800 may be seen to depict the operational entity comprising one or more physically separate devices for executing at least some of the described processes. Thus, the apparatus 800 of FIG. 9, utilizing such shared architecture, may comprise a remote control unit (RCU) 952, such as a host computer or a server computer, operatively coupled (e.g. via a wireless or wired network) to a remote radio head (RRH) 954 located in the base station. In an embodiment, at least some of the described processes may be performed by the RCU 952. In an embodiment, the execution of at least some of the described processes may be shared among the RRH 954 and the RCU 952.

In an embodiment, the RCU 952 may generate a virtual network through which the RCU 952 communicates with the RRH 954. In general, virtual networking may involve a process of combining hardware and software network resources and network functionality into a single, software-based administrative entity, a virtual network. Network virtualization may involve platform virtualization, often combined with resource virtualization. Network virtualization may be categorized as external virtual networking which combines many networks, or parts of networks, into the server computer or the host computer (i.e. to the RCU). External network virtualization is targeted to optimized network sharing. Another category is internal virtual networking which provides network-like functionality to the software containers on a single system. Virtual networking may also be used for testing the terminal device.

In an embodiment, the virtual network may provide flexible distribution of operations between the RRH and the RCU. In practice, any digital signal processing task may be performed in either the RRH or the RCU and the boundary where the responsibility is shifted between the RRH and the RCU may be selected according to implementation.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described in connection with FIGS. 1 to 6 may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments of FIGS. 1 to 6 or operations thereof. In an embodiment, these operations may comprise tasks, such as, transmitting, by a terminal device, a random access preamble to a network node, receiving, in response to the transmission of the random access preamble, a random access response from the network node, determining a transmission band based on the random access response, transmitting, in response to the reception of the random access response, a first scheduled transmission signal on the determined transmission band using sub-carrier-wise filtering, using sub-carrier group-wise filtering or by placing at least one blank value at an edge area of at least one frame used for the transmitting, receiving, in response to the transmission of the first scheduled transmission signal, a data transmission grant for a second scheduled transmission signal, and transmitting, to the network node, the second scheduled transmission signal based on the received data transmission grant. In an embodiment, these operations may comprise tasks, such as, receiving, by a network node, random access preambles from a plurality of terminal devices, determining propagation delays of the received random access preambles, generating terminal device specific receiving windows for the plurality of terminal devices based at least partly on a similarity of the random access preambles and the determined propagation delays, transmitting, in response to the receiving of the random access preambles, random access responses to the plurality of terminal devices, receiving, in response to the transmitting of the random access responses, first scheduled transmission signals in the terminal device specific receiving windows, transmitting, in response to the receiving of the first scheduled transmission signals, terminal device specific data transmission grants, wherein the data transmission grants are for second scheduled transmission signals, and receiving, in response to the transmitting of the data transmission grants, the second scheduled transmission signals.

According to yet another embodiment, the apparatus carrying out the embodiments comprises a circuitry including at least one processor and at least one memory including computer program code. When activated, the circuitry causes the apparatus to perform at least some of the functionalities according to any one of the embodiments of FIGS. 1 to 6, or operations thereof. In an embodiment, these operations may comprise tasks, such as, transmitting, by a terminal device, a random access preamble to a network node, receiving, in response to the transmission of the random access preamble, a random access response from the network node, determining a transmission band based on the random access response, transmitting, in response to the reception of the random access response, a first scheduled transmission signal on the determined transmission band using sub-carrier-wise filtering, using sub-carrier group-wise filtering or by placing at least one blank value at an edge area of at least one frame used for the transmitting, receiving, in response to the transmission of the first scheduled transmission signal, a data transmission grant for a second scheduled transmission signal, and transmitting, to the network node, the second scheduled transmission signal based on the received data transmission grant In an embodiment, these operations may comprise tasks, such as, receiving, by a network node, random access preambles from a plurality of terminal devices, determining propagation delays of the received random access preambles, generating terminal device specific receiving windows for the plurality of terminal devices based at least partly on a similarity of the random access preambles and the determined propagation delays, transmitting, in response to the receiving of the random access preambles, random access responses to the plurality of terminal devices, receiving, in response to the transmitting of the random access responses, first scheduled transmission signals in the terminal device specific receiving windows, transmitting, in response to the receiving of the first scheduled transmission signals, terminal device specific data transmission grants, wherein the data transmission grants are for second scheduled transmission signals, and receiving, in response to the transmitting of the data transmission grants, the second scheduled transmission signals.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described in connection with FIGS. 1 to 6 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1.-49. (canceled)

50. A method comprising:
transmitting a random access preamble to a network node;
receiving, in response to the transmission of the random access preamble, a random access response from the network node;
determining a transmission band based on the random access response;
transmitting, in response to the reception of the random access response, a first scheduled transmission signal on the determined transmission band using sub-carrier-wise filtering, using sub-carrier group-wise filtering or by placing at least one blank value at an edge area of at least one frame used for the transmitting;
receiving, in response to the transmission of the first scheduled transmission signal, a data transmission grant for a second scheduled transmission signal; and
transmitting, to the network node, the second scheduled transmission signal based on the received data transmission grant.

51. The method of claim 50, wherein the sub-carrier-wise filtering comprises filtering per at least one sub-carrier of the first scheduled transmission signal.

52. The method of claim 50, wherein the sub-carrier group-wise filtering comprises filtering per group of sub-carriers within a sub-band of the transmission band.

53. The method of claim 50, further comprising:
placing at least one blank value at an edge area of at least one frame used for the transmission of the second scheduled transmission.

54. The method claim 50, wherein at least one of the following:
the placing of the at least one blank value at the edge area of the at least one frame used for the transmission of the first scheduled transmission signal is performed by placing a set of zeros at a tail of Orthogonal Frequency Division Multiple Access or Single Carrier Frequency Division Multiple Access symbols of the first scheduled transmission signal and by using a zero-tail Discrete Fourier Transform-spread-Orthogonal Frequency Division Multiplexing, ZT-DFT-s-OFDM, modulation; and
the placing of the at least one blank value at the edge area of the at least one frame used for the transmission of the second scheduled transmission signal is performed by placing a set of zeros at a tail of Orthogonal Frequency Division Multiple Access or Single Carrier Frequency Division Multiple Access symbols of the second scheduled transmission signal and by using a zero-tail Discrete Fourier Transform-spread-Orthogonal Frequency Division Multiplexing, ZT-DFT-s-OFDM, modulation.

55. The method of claim 50, further comprising:
adjusting at least one of a timing advance value of the transmission of the first scheduled transmission signal and a timing advance value of the transmission of the second scheduled transmission signal.

56. The method claim 50, further comprising:
determining that the apparatus is within a sub-region of a cell provided by the network node; and
adjusting a timing advance of the random access preamble transmission based on to the determined sub-region.

57. An apparatus comprising at least one processor and at least one memory including a computer program code, wherein the at least one memory and the computer program code are configured, with the at least one processor, to cause the apparatus to:
transmit a random access preamble to a network node;
receive, in response to the transmission of the random access preamble, a random access response from the network node;
determine a transmission band based on the random access response;
transmit, in response to the reception of the random access response, a first scheduled transmission signal on the determined transmission band using sub-carrier-wise filtering, using sub-carrier group-wise filtering or by placing at least one blank value at an edge area of at least one frame used for the transmitting;
receive, in response to the transmission of the first scheduled transmission signal, a data transmission grant for a second scheduled transmission signal; and
transmit, to the network node, the second scheduled transmission signal based on the received data transmission grant.

58. The apparatus of claim 57, wherein the sub-carrier-wise filtering comprises filtering per at least one sub-carrier of the first scheduled transmission signal.

59. The apparatus of claim 57, wherein the sub-carrier group-wise filtering comprises filtering per group of sub-carriers within a sub-band of the transmission band.

60. The apparatus of claim 57, wherein the at least one memory and the computer program code are configured, with the at least one processor, to cause the apparatus further to perform: place at least one blank value at an edge area of at least one frame used for the transmission of the second scheduled transmission.

61. The apparatus of claim 57, wherein at least one of the following:
the placing of the at least one blank value at the edge area of the at least one frame used for the transmission of the first scheduled transmission signal is performed by placing a set of zeros at a tail of Orthogonal Frequency Division Multiple Access or Single Carrier Frequency Division Multiple Access symbols of the first scheduled transmission signal and by using a zero-tail Discrete Fourier Transform-spread-Orthogonal Frequency Division Multiplexing, ZT-DFT-s-OFDM, modulation; and
the placing of the at least one blank value at the edge area of the at least one frame used for the transmission of the second scheduled transmission signal is performed by placing a set of zeros at a tail of Orthogonal Frequency Division Multiple Access or Single Carrier Frequency Division Multiple Access symbols of the second scheduled transmission signal and by using a zero-tail Discrete Fourier Transform-spread-Orthogonal Frequency Division Multiplexing, ZT-DFT-s-OFDM, modulation.

62. The apparatus of claim 57, wherein the at least one memory and the computer program code are configured, with the at least one processor, to cause the apparatus further to perform:
adjust at least one of a timing advance value of the transmission of the first scheduled transmission signal and a timing advance value of the transmission of the second scheduled transmission signal.

63. The apparatus of claim 57, wherein the at least one memory and the computer program code are configured, with the at least one processor, to cause the apparatus further to perform:
determine that the apparatus is within a sub-region of a cell provided by the network node; and adjust a timing advance of the random access preamble transmission based on the determined sub-region.

64. The apparatus of claim 63, wherein the timing advance value of the random access preamble transmission is adjusted by a value obtained from a uniformly distributed function.

65. A non-transitory computer readable medium storing a program that, when executed by a processor, causes an apparatus to execute a process comprising:
transmitting a random access preamble to a network node;
receiving, in response to the transmission of the random access preamble, a random access response from the network node;
determining a transmission band based on the random access response;
transmitting, in response to the reception of the random access response, a first scheduled transmission signal on the determined transmission band using sub-carrier-wise filtering, using sub-carrier group-wise filtering or by placing at least one blank value at an edge area of at least one frame used for the transmitting;
receiving, in response to the transmission of the first scheduled transmission signal, a data transmission grant for a second scheduled transmission signal; and
transmitting, to the network node, the second scheduled transmission signal based on the received data transmission grant.

66. The non-transitory computer readable medium of claim 65, wherein the sub-carrier-wise filtering comprises filtering per at least one sub-carrier of the first scheduled transmission signal.

67. The non-transitory computer readable medium of claim 65, wherein the sub-carrier group-wise filtering comprises filtering per group of sub-carriers within a sub-band of the transmission band.

68. The non-transitory computer readable medium of claim 65, the process further comprising:
placing at least one blank value at an edge area of at least one frame used for the transmission of the second scheduled transmission.

69. The non-transitory computer readable medium of claim 65, wherein at least one of the following:
the placing of the at least one blank value at the edge area of the at least one frame used for the transmission of the first scheduled transmission signal is performed by placing a set of zeros at a tail of Orthogonal Frequency Division Multiple Access or Single Carrier Frequency Division Multiple Access symbols of the first scheduled transmission signal and by using a zero-tail Discrete Fourier Transform-spread-Orthogonal Frequency Division Multiplexing, ZT-DFT-s-OFDM, modulation; and
the placing of the at least one blank value at the edge area of the at least one frame used for the transmission of the second scheduled transmission signal is performed by placing a set of zeros at a tail of Orthogonal Frequency Division Multiple Access or Single Carrier Frequency Division Multiple Access symbols of the second scheduled transmission signal and by using a zero-tail Discrete Fourier Transform-spread-Orthogonal Frequency Division Multiplexing, ZT-DFT-s-OFDM, modulation.
